(19) United States
(12) Patent Application Publication
(10) Pub. No.: US 2013/0149928 A1
(43) Pub. Date: Jun. 13, 2013

(54) LOW FORMALDEHYDE AND HIGH WET STRENGTH POLYMER BINDER

(71) Applicants: John Richard Boylan, Bethlehem, PA (US); Conrad William Perry, Wescosville, PA (US)

(72) Inventors: John Richard Boylan, Bethlehem, PA (US); Conrad William Perry, Wescosville, PA (US)

(73) Assignee: Wacker Chemical Corporation, Adrian, MI (US)

(21) Appl. No.: 13/313,450

(22) Filed: Dec. 7, 2011

(51) Int. Cl. B32B 5/02; B05D 3/00; C09D 133/26; B05D 7/24; C09D 129/04; C09D 131/04

(52) U.S. Cl. 442/59; 524/503; 427/385.5

(57) ABSTRACT

An aqueous composition includes a blend of:
a) an aqueous dispersion of a vinyl acetate ethylene or vinyl acetate polymer, stabilized by polyvinyl alcohol and optionally also by a surfactant, wherein the polymer does not include units of any N-methylol-containing monomer; and
b) an aqueous dispersion of an N-methylol-containing vinyl acetate ethylene or vinyl acetate polymer, stabilized with a surfactant, polyvinyl alcohol or a combination thereof.

A method of increasing the wet strength of a fibrous nonwoven substrate includes applying to the substrate the abovementioned aqueous composition, followed by a drying step. A fibrous nonwoven article is produced.

### BACKGROUND OF THE INVENTION

Vinyl acetate ethylene (VAE) copolymer and vinyl acetate (VA) homopolymer dispersions containing N-methylolacrylamide (NMA) as a self-crosslinking functional monomer are often applied to nonwoven substrates to provide good dry and wet tensile strength, as well as good water absorptivity. Examples of such substrates include airlaid nonwoven substrates used for wet wipe end-use applications. Wet wipes have an aqueous composition, such as a lotion, impregnated into the substrate to afford a wet texture, and therefore must have good wet tensile strength.

During the NMA crosslinking, however, formaldehyde is produced as an undesirable by-product. In addition, in many cases formaldehyde is also present in the dispersion prior to crosslinking due to the use of sodium formaldehyde sulfoxylate (SFS) as a redox radical initiator in forming the VAE copolymer. Formaldehyde may also be present due to the use of certain preservatives. The presence of formaldehyde in the dispersion, as well as in the substrate after the crosslinking reaction, is, however, undesirable for both the manufacturer of the substrate as well as the end use consumer. Efforts to use VAE or VA resins not containing NMA or other crosslinking monomers, however, have typically resulted in insufficient wet tensile strength. Thus, a need exists for methods and compositions capable of providing acceptable wet and dry tensile strength while minimizing generation of formaldehyde.

In U.S. Pat. No. 5,143,954 a nonwoven binder with low-formaldehyde is described, employing an N-methylol functional polymer latex and a formaldehyde-scavenging agent.

U.S. Pat. No. 4,449,978 discloses nonwoven products having formaldehyde content of less than 50 ppm in the nonwoven. In the nonwoven binder N-methylol acrylamide is partially substituted by acrylamide. Ammonium chloride is disclosed as a suitable catalyst for inducing crosslinking of the N-methylol units.

U.S. Pat. No. 5,540,987 describes reduction of free formaldehyde content by using a particular initiator system during polymerization comprising a hydrophobic hydroperoxide and ascorbic acid. The reduction in free formaldehyde comes from the use of the this non-formaldehyde reducing agent vs a formaldehyde generating reducing agent such as sodium formaldehyde sulfoxylate.

U.S. Pat. No. 7,153,791 and U.S. Pat. No. 7,247,586 disclose a nonwoven binder which comprises a blend of an emulsion polymerized ethylene vinyl chloride polymer and an emulsion polymerized self crosslinkable vinyl acetate-ethylene-N-methylolacrylamide polymer. The formaldehyde content is not discussed. The blends of dispersion disclosed in this patent include an ethylene vinyl chloride copolymer with a self crosslinking VAE utilizing NMA. The ethylene vinyl chloride copolymer acts as an acid catalyst substitute at low levels.

U.S. Pat. No. 4,481,250 describes a mixture of a vinyl acetate-ethylene crosslinking monomer copolymer with a vinyl acetate ethylene copolymer. The combination is said to add heat sealing properties via the vinyl acetate ethylene copolymer to the wet tensile strength achieved with the crosslinkable copolymer.

Despite the abovementioned advances, there remains a need for simple and cost-effective ways of providing dry and wet tensile strength to nonwovens while reducing the amount of formaldehyde generated.

### SUMMARY OF THE INVENTION

In one aspect, the invention provides an aqueous composition including a blend of:

a) an aqueous dispersion of a vinyl acetate ethylene or vinyl acetate polymer, stabilized by polyvinyl alcohol and optionally also by a surfactant, wherein the polymer does not include units of any N-methylol-containing monomer; and

b) an aqueous dispersion of an N-methylol-containing vinyl acetate ethylene or vinyl acetate polymer, stabilized with a surfactant, polyvinyl alcohol or a combination thereof.

In another aspect, the invention provides a method of increasing the wet strength of a fibrous nonwoven substrate, including applying to the substrate the above-mentioned aqueous composition, followed by a drying step.

In yet another aspect, the invention provides a fibrous nonwoven article made by the immediately foregoing method.

### DETAILED DESCRIPTION OF THE INVENTION

It has now been found that excellent wet tensile performance with low formaldehyde levels within a nonwoven or paper is achieved through the application of a formulated blend of two different dispersions:

a) a dispersion of a vinyl acetate ethylene (VAE) polymer or a vinyl acetate polymer stabilized by polyvinyl alcohol (PVOH) or PVOH and a surfactant,

b) a dispersion of an N-methylol-containing VAE or vinyl acetate polymer stabilized with either or both of a surfactant or PVOH.

The N-methylol functionality in VAE or VA of dispersion b) contributes substantial levels of wet strength when used as a nonwoven or paper binder, due to the self cross linking nature of the methylol groups in the polymer backbone. On the other hand, a non-methylol containing VAE of dispersion a), if used alone, contributes very little if any wet strength to a nonwoven or paper because it does not undergo crosslinking. It would therefore have been expected that, if the two types were blended, the wet strength performance would decrease in direct proportion to the amount of non-methylol containing VAE in the blend. However, it has now been found that a surprising wet strength synergy exists between the two dispersions when a nonwoven is bound with a high blend ratio of the non self-crosslinking VAE/VA dispersion a) to the self-crosslinking VAE/VA dispersion b). Typically, the N-methylol functionality will be provided by including N-methylolacrylamide (NMA) in the polymer of dispersions b), and for simplicity that dispersion will frequently be described herein as an NMA-containing dispersion. However, other crosslinking groups may be used instead or in addition to NMA, as discussed below.

The blending ratio depends on the level of wet tensile performance required by a given application. Usually the polymer of dispersion a) constitutes at least 5%, or at least 10%, or at least 20%, or at least 30% by weight of the polymer in the blend, with the balance being the polymer of dispersion b). In some embodiments, even higher amounts of polymer a) may be used. The amount may be at least 40%, or at least 50%, or at least 60%, or at least 70%, or at least 80%, or at least 90%, since the synergistic effect occurs over a very broad range of compositions. Compositions including high levels of polymer a), and thus low levels of polymer b), typically provide low levels of formaldehyde and thus are advantageous in some embodiments.

Both VA and VAE dispersions are suitable for use according to the invention for dispersion a) and dispersion b), but for simplicity the dispersion or polymer may be referred to herein as a VAE dispersion or polymer and it will be understood that such use of the term “VAE” includes VA unless the context clearly indicates otherwise.

Dispersions a) and b) will now be described.

### Dispersion a)

Dispersion a) is obtained by emulsion polymerization of 66 to 100% by weight vinyl acetate and 0 to 34% by weight of ethylene, based in each case on the total weight of the comonomers, in the presence of polyvinyl alcohol.

In general the vinyl acetate fraction is 66% to 100% by weight, preferably 68% to 95% by weight, more preferably 68% to 93% by weight, and most preferably 68% to 92% by weight, based in each case on the total weight of the vinyl acetate and ethylene monomers. The ethylene fraction is preferably 0% to 34% by weight, more preferably 2% to 32% by weight and most preferably 5% to 32% by weight, based in each case on the total weight of the comonomers.

### Dispersion b)

Dispersion b) may be obtained by emulsion polymerization of 66 to 99.95% by weight vinyl acetate and 0 to 34% by weight of ethylene, and 0.03 to 6% of an N-methylol-functional comonomer based in each case on the total weight of the comonomers, in the presence of polyvinyl alcohol and/or an emulsifier. In some embodiments acrylamide is also included, typically at a level constituting from 0.02 to 4% of the total monomer comonomer weight.

For the polymer of dispersion b), in general the vinyl acetate fraction is 66% to 99.95% by weight, preferably 68% to 95% by weight, more preferably 68% to 93% by weight, and most preferably 68% to 92% by weight, based in each case on the total weight of the vinyl acetate and ethylene monomers. The ethylene fraction is preferably 0% to 34% by weight, more preferably 2% to 32% by weight and most preferably 5% to 32% by weight, based in each case on the total weight of the comonomers.

Suitable N-methylol-functional comonomers for making the polymer of dispersion b) are for example, N-methylolacrylamide (NMA), N-methylolmethacrylamide, allyl N-methylolcarbamate, the alkyl ethers such as isobutyl ether, or esters of N-methylolacrylamide, of N-methylol-methacrylamide or of allyl N-methylolcarbamate. N-methylolacrylamide and N-methylol-methacrylamide are particularly preferred. The fraction of the N-methylol-functional comonomer in polymer of dispersion b) is in general 0.03 to 6% by weight, preferably 0.3 to 6% by weight, most preferably 0.3 to 3% by weight, based in each case on the total weight of the comonomers.

If acrylamide is included in the polymer of dispersion b), the amount will generally be from 0.02 to 4% by weight, preferably 0.2 to 4% by weight, most preferably 0.2 to 2% by weight, based on the total weight of the comonomers.

Optionally, in some embodiments the range of available properties for the polymers in dispersion a) and/or dispersion b) may be extended by copolymerizing additional comonomers with vinyl acetate, or with vinyl acetate and ethylene. Typically, suitable comonomers are monomers with a single polymerizable olefinic group. Examples of such comonomers are vinyl esters of carboxylic acids having 3 to 18 C atoms. Preferred vinyl esters are vinyl propionate, vinyl butyrate, vinyl 2-ethylhexanoate, vinyl laurate, 1-methyl vinyl acetate, vinyl pivalate, and vinyl esters of α-branched monocarboxylic acids having 9 to 11 C atoms, examples being VEOVA9™ or VEOVA10™ esters (available from Momentive Specialty Chemicals, Houston, Tex.). Other suitable comonomers include esters of acrylic acid or methacrylic acid with unbranched or branched alcohols having 1 to 15 C atoms. Exemplary methacrylic esters or acrylic esters include methyl acrylate, methyl methacrylate, ethyl acrylate, ethyl methacrylate, propyl acrylate, propyl methacrylate, n-butyl acrylate, n-butyl methacrylate, 2-ethylhexyl acrylate and norbornyl acrylate. Other suitable comonomers include vinyl halides such as vinyl chloride, or olefins such as propylene. In general the further comonomers are copolymerized in an amount of 0.5 to 30 wt %, preferably 0.5 to 20 wt %, based on the total amount of comonomers in the copolymer.

Optionally, 0.05% to 10% by weight, based on the total amount of vinyl acetate and ethylene, of other monomers (auxiliary monomers) may additionally be copolymerized in forming dispersion a) and/or dispersion b). Auxiliary monomers include a polymerizable olefinic group and at least one additional functional group, which may be an additional polymerizable olefinic group so as to provide crosslinking. Other functional groups may include reactive groups such as carboxylic or sulfonic acid groups.

Examples of auxiliary monomers are ethylenically unsaturated monocarboxylic and dicarboxylic acids, typically acrylic acid, methacrylic acid, fumaric acid and maleic acid; ethylenically unsaturated carboxamides and carbonitriles, typically acrylamide and acrylonitrile; monoesters and diesters of fumaric acid and maleic acid, such as the diethyl and diisopropyl esters, and also maleic anhydride, ethylenically unsaturated sulphonic acids and their salts, typically vinylsulphonic acid, 2-acrylamido-2-methylpropanesulphonic acid. Other examples are pre-crosslinking comonomers such as polyethylenically unsaturated comonomers, examples being divinyl adipate, diallyl maleate, allyl methacrylate or triallyl cyanurate. Also suitable are epoxy-functional comonomers such as glycidyl methacrylate and glycidyl acrylate. Other examples are silicon-functional comonomers, such as acryloyloxypropyltri(alkoxy)- and methacryloyloxypropyltri(alkoxy)silanes, vinyltrialkoxysilanes and vinylmethyldialkoxysilanes, alkoxy groups that may be present being, for example, methoxy, ethoxy and ethoxypropylene glycol ether radicals. Additional monomers comprise hydroxyl or CO groups, examples being methacrylic and acrylic hydroxyalkyl esters such as hydroxyethyl, hydroxypropyl or hydroxybutyl acrylate or methacrylate, and also compounds such as diacetoneacrylamide and acetylacetoxyethyl acrylate or methacrylate.

While some applications may favor the inclusion of additional monomers in the VAE, for example such as those listed above, it may nonetheless in some cases be advantageous to exclude certain monomers in making the polymeric binder, depending on the specific needs of a given application. In other cases, these monomers may be included up to a limit of 1.0 wt % of the polymeric binder. The excluded or limited monomers may include any one or more of the following: i-butoxy methylacrylamide; acrylamidoglycolic acid; acrylamidobutyraldehyde; dialkyl acetals of acrylamidobutyraldehyde; glycidyl-containing compounds (e.g., glycidyl (meth)acrylate, triglycidyl isocyanurate, etc.); ethylenically unsaturated phosphates, phosphonates or sulfates; ethylenically unsaturated silicon compounds; (meth)acrylamide or N-substituted meth)acrylamides; (meth)acrylic esters; vinyl ethers; acrylonitrile; butadiene; styrene; vinyltoluene; divinyl benzene and/or other olefinically unsaturated hydrocarbons other than ethylene; halogenated monomers (e.g., vinyl chloride); and esters of allyl alcohol.

In some embodiments of the invention, only VA homopolymers and/or VAE copolymers not containing further comonomer units or auxiliary monomers are used in making dispersion a). In some embodiments of the invention, only VA homopolymers and/or VAE copolymers including methylol-containing monomer(s) but no further comonomer units or auxiliary monomers are used in making dispersion b).

The choice of monomers or the choice of the proportions by weight of the comonomers is preferably made in such a way that, in general, a glass transition temperature Tg of from −30° C. to +35° C. results. The glass transition temperature Tg of the polymers can be determined in a known way by means of differential scanning calorimetry (DSC). The Tg can also be calculated approximately beforehand by means of the Fox equation. According to Fox T. G., Bull. Am. Physics Soc. 1, 3, page 123 (1956): 1/Tg=x1/Tg1+×2/Tg2+ . . . +xn/Tgn, where xn is the mass fraction (% by weight/100) of the monomer n and Tgn is the glass transition temperature in kelvin of the homopolymer of the monomer n. Tg values for homopolymers are given in the Polymer Handbook 2nd Edition, J. Wiley & Sons, New York (1975).

### Polyvinyl Alcohol (PVOH)

Polyvinyl alcohols are partially hydrolysed or fully hydrolysed polyvinyl acetates having an average degree of hydrolysis of 80 to 99.9 mol %. Suitable PVOH for use in preparing dispersion a) or b) may include ultra-low viscosity (3-4 cps for a 4% aqueous solution), low viscosity (5-6 cps for a 4% aqueous solution), medium viscosity (22-30 cps for a 4% aqueous solution) and high viscosity (45-72 cps for a 4% aqueous solution) varieties. Ultra-low viscosity PVOH has a mass-average degree of polymerization of 150-300 and a weight average molecular weight of 13,000-23,000. Low viscosity PVOH has a mass-average degree of polymerization of 350-650 and a weight average molecular weight of 31,000-50,000. Medium viscosity PVOH has a mass-average degree of polymerization of 1000-1500 and a weight average molecular weight of 85,000-124,000. High viscosity PVOH has a mass-average degree of polymerization of 1600-2200 and a weight average molecular weight of 146,000-186,000. Any polyvinyl alcohol (PVOH) may be used according to the invention. In some embodiments, the viscosity of the PVOH is ultra-low, low or medium.

Weight average molecular weight and degree of polymerization of polyvinyl alcohol is typically determined by using size exclusion chromatography/gel permeation chromatography measurement techniques. Viscosity of polyvinyl alcohol is typically measured on a 4% solids aqueous solution of the PVOH using a Höppier falling-ball viscometer (DIN 53 015) or an Ubbelohde viscometer (capillary viscometer, DIN 51 562 and DIN 53 012). It is international practice to state the viscosity of 4% aqueous polyvinyl alcohol solutions at 20° C.

In some embodiments, suitable examples of PVOH include partially hydrolysed polyvinyl acetates or mixtures of having an average degree of hydrolysis of 80 to 96 mol %. Particular preference is given to partially hydrolysed polyvinyl acetate having an average degree of hydrolysis of 86 to 90 mol %, typically in each case having a mass-average degree of polymerization of 150 to 2200. To adjust the viscosity of the resulting polymer dispersion it may be advantageous to use mixtures of polyvinyl alcohols with different degrees of polymerization, in which case the degrees of polymerization of the individual components may be smaller or greater than the mass-average degree of polymerization, of 150 to 2200, of the mixture.

In some embodiments, suitable PVOH examples include fully hydrolysed polyvinyl acetates, i.e., those having an average degree of hydrolysis of 96.1 to 99.9 mol %, typically having an average degree of hydrolysis of 97.5 to 99.5 mol %, alone or in mixtures with partially hydrolysed polyvinyl acetates, the fully hydrolysed examples typically having a mass-average degree of polymerization of 150 to 2200.

Alternatively, or in addition, in some embodiments it may be useful to employ modified polyvinyl alcohols. For example, these may include PVOH containing functional groups, such as acetoacetyl groups, for example, or PVOH comprising comonomer units, such as vinyl laurate-modified or VERSATIC™ acid vinyl ester-modified polyvinyl alcohols, for example. VERSATIC™ acid vinyl esters are available from Momentive Specialty Chemicals under the trade name VEOVA™, for example VEOVA™ 9 and VEOVA™ 10. Also suitable are ethylene-modified polyvinyl alcohols, which are known, for example, under the trade name EXCEVAL™ polymer (Kuraray America, Inc., Houston, Tex.). These can be used either alone or in combination with standard unsubstituted polyvinyl alcohols. Preferred ethylene-modified polyvinyl alcohols have an ethylene fraction of up to 12 mol %, preferably 1 to 7 mol % and more preferably 2 to 6 mol %; 2 to 4 mol % in particular. The mass-average degree of polymerization is in each case from 500 to 5000, preferably 2000 to 4500, and more preferably 3000 to 4000, based on molecular weight data obtained via Aqueous Gel Permeation Chromatography.

The average degree of hydrolysis is generally greater than 92 mol %, preferably 94.5 to 99.9 mol %, and more preferably 98.1 to 99.5 mol %. Of course, it is also possible, and may be advantageous, to use mixtures of different ethylene-modified polyvinyl alcohols, alone or in combination with partially hydrolysed and/or fully hydrolysed standard polyvinyl alcohols.

The PVOH serving as the emulsion stabilizer will typically be present at a level of 1 to 10 parts per 100 parts of polymer by weight. More typically, the level will be from 2 to 8 parts, or from 4 to 5 parts.

### Preparation of VAE Dispersions

VAE dispersions stabilized with polyvinyl alcohol may be prepared by emulsion polymerization, typically at a temperature in a range from 40° C. to 100° C., more typically 50° C. to 90° C. and most typically 60° C. to 80° C. The polymerization pressure is generally between 40 and 100 bar, more typically between 45 and 90 bar, and may vary particularly between 45 and 85 bar, depending on the ethylene feed. Polymerization may be initiated using a redox initiator combination such as is customary for emulsion polymerization.

Redox initiator systems may be used to prepare VAE emulsions suitable for use according to the invention. The initiators may be formaldehyde-generating redox initiation systems such as sodium formaldehyde sulfoxylate. In some embodiments, however, it is desirable to minimize the formaldehyde level in the dispersion and therefore in the VAE bound nonwoven substrate. In such cases, it is desirable to use a VAE prepared with a non-formaldehyde generating redox initiation system. In general, suitable non-formaldehyde generating reducing agents for redox pairs include, as non-limiting examples, those based on ascorbic, bisulfite, erythorbate or tartaric chemistries as known in the art, and a commercial reducing agent known as BRUGGOLITE® FF6M manufactured by Bruggeman Chemical of Heilbronn, Germany. Non-redox initiators may also be used, such as persulfates, peroxides and azo-type initiators, all of which are well known in the art.

During polymerization the dispersion may be stabilized with polyvinyl alcohol (PVOH) or a combination of PVOH and a surfactant (emulsifier). The polyvinyl alcohol is present during the polymerization generally in an amount totaling 1% to 10% by weight, preferably 2% to 8% by weight, more preferably 4% to 5% by weight, based in each case on the total weight of the monomers.

It is preferable not to add emulsifiers in the polymerization for making dispersion a). In exceptional cases it can be advantageous to make concomitant use of small amounts of emulsifiers, typically from 1 to 5% by weight, based on the amount of monomer. Suitable emulsifiers are either anionic or cationic or nonionic emulsifiers, for example anionic surfactants, such as alkyl sulfates whose chain length is from 8 to 18 carbon atoms, alkyl or alkylaryl ether sulfate having from 8 to 18 carbon atoms in the hydrophobic radical and up to 40 ethylene oxide or propylene oxide units, alkyl- or alkylarylsulfonates having from 8 to 18 carbon atoms, esters and half-esters of sulfosuccinic acid with monohydric alcohols or alkylphenols, or nonionic surfactants, such as alkyl polyglycol ethers or alkylaryl polyglycol ethers having from 8 to 40 ethylene oxide units. Preferred are nonionic, ethoxylated emulsifiers with a branched or linear alkyl radical or in the form of ethylene oxide-propylene oxide copolymers. Preferably, these surfactants do not contain alkyl phenol ethoxylate structures and are not endocrine disruptors.

For some embodiments of dispersion type b), an emulsifier is used in the absence of PVOH, as surfactant-protected VAE dispersions tend to have lower viscosity. This facilitates application of the dispersion onto a substrate, such as a nonwoven or paper substrate. Additionally, dispersions of type b) stabilized with PVOH may slowly rise in viscosity with time, hindering the application process.

All of the monomers may form an initial charge, or all of the monomers may form a feed, or portions of the monomers may form an initial charge and the remainder may form a feed after the polymerization has been initiated. The feeds may be separate (spatially and chronologically), or all or some of the components may be fed after pre-emulsification. Once the polymerization process has ended, post-polymerization may be carried out using known methods to remove residual monomer, one example of a suitable method being post-polymerization initiated by a redox catalyst. Volatile residual monomers may also be removed by distillation, preferably at subatmospheric pressure, and, where appropriate, by passing inert entraining gases, such as air, nitrogen, or water vapor, through or over the material.

The solids content of suitable VAE dispersions are typically in a range from 45% to 75% by weight, but dispersions with other solids levels may be used.

The aqueous polymer composition according to the present invention may be prepared by mixing dispersion a) with dispersion b). It is not critical for the present invention how and when dispersions a) and b) are mixed. For example the dispersions may be mixed immediately after they are formed, or later. The most suitable mixing method may be readily selected by the person skilled in the art depending, for example, on the intended end use of the polymer composition. The mixing procedure can be carried out by using conventional mixing equipment.

### Acids

One or more acids may optionally be formulated with the PVOH-containing VAE composition to provide increased wet strength. Acid catalysts known in the art to promote self crosslinking of NMA-containing polymers are typically suitable. Suitable acids include organic acids such as acetic acid or citric acid. In some embodiments, mineral acids or other inorganic or non-carboxylic acids are used. Nonlimiting examples include hydrochloric, nitric, sulfuric, phosphoric, and perchloric acid. Partial alkali metal or ammonium salts of di- or tri-protic acids may also be used. Nonlimiting examples include sodium, potassium and ammonium bisulfate, and monosodium, monopotassium and monoammonium phosphate.

Salts formed by reaction of acids with fugitive bases, such as ammonium chloride, in which the ammonia evaporates in use and leaves the acid (HCl) behind in the treated nonwoven, are considered to be catalytic acids for purposes of the invention. Reference to the pKa of such a salt will be understood to refer to the pKa of the acid itself (e.g., HCl, in the case of ammonium chloride). Nonlimiting examples of such acids include ammonium sulfate, ammonium chloride, and ammonium phosphate. In some embodiments, the pKa of the acid is at most 4.0, or at most 3.5, or at most 2.5, or at most 2.0.

Polymeric carboxylic acids are not suitable catalytic acids for purposes of the invention. Thus, for example, homopolymers or copolymers containing acrylic acid, maleic acid or fumaric acid units are not suitable catalysts according to the invention, and thus these and/or other polymeric carboxylic acids may in some embodiments be excluded from the compositions of this invention.

If acid is used, the amount of acid in the formulation will typically be at least 0.1 parts, or at least 0.2 parts, or at least 0.5 parts, or at least 1 part, measured as dry parts based per 100 parts of VAE polymer (including both of the polymers from dispersions a) and b)) on a dry weight basis. Typically the amount will be at most 5 parts, or at most 4 parts, or at most 3 parts. In the systems tested here, wet strength is expected to level out with inclusion of 1 to 3 parts of acid.

The acid may be formulated with either or both of dispersion a) and dispersion b), or their blend, or it may be added separately to a substrate treated with the blend, either before or after drying the blend on the substrate.

### Treatment of Nonwoven Substrates

The binder composition is typically applied to a nonwoven substrate via spray application, saturation, gravure printing or foaming. The formulation is typically applied at a solids level between 0.5 to 30% depending on the desired add-on, and typically contains the optional acid (if used). After the formulation is applied to the substrate, the substrate is dried. This is typically done at a temperature in a range from 120° C. to 160° C., but higher or lower temperatures may be used. A wetting additive can also be included in the treatment composition to aid in the wetting of not only the formulated binder on the substrate, but also wetting of the subsequent finished fibrous nonwoven substrate. One example is AEROSOL® OT, a sodium dioctyl sulfosuccinate. The wetting agent can be added into the formulation at level of 0.1 to 3 dry parts based on the weight of dry polymer but is more typically formulated at between 0.5 and 2 parts.

An alternative application method is to first apply the blend of dispersions a) and b) to the nonwoven substrate (with or without the wetting additive) and dry the binder on the substrate, and then apply the acid alone to the dried, VAE bound nonwoven and again dry the substrate. For each drying step individually, the temperature is typically in a range from 120° C. to 160° C., but higher or lower temperatures may be used.

The fibrous material used in the nonwoven substrate can be a natural fiber such as (but not limited to) cellulose fiber, or a synthetic fiber including but not limited to one or more of polyester, polyethylene, polypropylene and polyvinyl alcohol, or viscose fiber, or a combination of any of these. The fibrous nonwoven substrate itself can be produced according to any of various methods known in the art, including but not limited to airlaid, wet laid, carding, and hydroentanglement.

By using blended dispersions according to the invention, it is possible to obtain good wet strength performance with reduced generation of formaldehyde because only a portion of the polymer (i.e., the dispersion b) polymer) contains methylol groups, the main source of formaldehyde in VAE-type binder compositions. The other common source of formaldehyde results from the use of a sodium formaldehyde sulfoxylate redox initiation system in the polymerization reaction used to make the dispersion. In some embodiments of the invention, therefore, it is desirable to further reduce formaldehyde generation by using a formaldehyde-free polymerization initiator for making dispersion a) and dispersion b).

As seen in the following examples, excellent wet strength performance may be obtained using the compositions and methods of the invention. The following examples illustrate the nonwoven wet strength synergy between a PVOH stabilized VAE and an NMA containing, surfactant stabilized VAE when blended together in a formulation and spray applied to an airlaid nonwoven.

### EXAMPLES

To demonstrate the synergistic blend effect described above, several blends of a PVOH-stabilized VAE dispersion (dispersion a)) and of a surfactant stabilized NMA-functional VAE dispersion (dispersion b)) were formulated at various ratios and applied to a nonwoven. Each blend was formulated with and with out ammonium chloride. A wetting surfactant, AEROSOL® OT, was added to each formulation. The formulations were prepared to a total solids level of 20%. The general recipe of the formulations was as follows:

| Ingredient | Dry Parts | |
|---|---|---|
| Total VAE binder | 100 | parts |
| AEROSOL ® OT | 1 | part |
| Ammonium Chloride | 0/1 | part |

Dispersion 1 was a PVOH-stabilized VAE dispersion having a solids content of 55 wt %, with the copolymer containing 90 wt % of vinyl acetate and 10 wt % of ethylene and having a glass transition temperature of 17° C. The dispersion was stabilized with 3.9 wt % of PVOH (88 mol-% degree of hydrolysis) based on copolymer weight. This dispersion was prepared using a non-formaldehyde generating redox initiation system.

Dispersion 2 was a surfactant stabilized VAE with 77% by weight of vinyl acetate and 14% by weight of ethylene and with 4.8% by weight of a 1 to 1 molar blend of NMA and acrylamide. The blend is commercially available from Cytec Industries Inc., Woodland Park, N.J. as a 48% actives aqueous solution under the tradename NMA-LF. Stabilization was with 2.5% by weight of surfactant relative to polymer, and the solids content of the dispersion was 52%.

Dispersion 3 was similar to Dispersion 2, except that the Tg of Dispersion 3 was lower due to a greater amount of ethylene in the polymer (31%% ethylene and 66% vinyl acetate).

AEROSOL® OT is commercially available through CYTEC Industries, Inc.

The various formulations were sprayed applied to a 90 gsm airlaid substrate having 88 wt % cellulose fibers and 12 wt % synthetic bi-component fibers consisting of a polyester core and a polyethylene sheath.

The formulations were spray applied to the airlaid substrate to achieve an add-on of ˜20% dry formulation on dry substrate. The substrates were then dried after binder formulation application in a through air oven at a temperature of 150° C. for 3 minutes. The dried substrates were conditioned overnight in a constant temperature and humidity room at 72° F. and 50% relative humidity. After conditioning overnight, the substrates were tested for wet and dry breaking tensile strength using an Instron tensile tester following ASTM method D 5035-95. The results of the substrate tensile testing are shown in Table 1. The dispersion formaldehyde measurements were performed following ASTM D5910-96.

TABLE 1
Wet/Dry Tensile Strength of Airlaid Bound with VAE Blend Formulations

| | | | | | | 50% Solids |
|---|---|---|---|---|---|---|
| | | | Substrate | Dry Tensile | Wet Tensile | Dispersion |
| Example | | Add-on | Basis Weight | Strength | Strength | Formaldehyde |
| No. | Condition | % | grams/sq. meter | grams/5 cms | grams/5 cms | Level ppm |
| 1 | 100% Dispersion No. 2 | 19.0 | 102.3 | 3695 | 1620 | 52.5 |
| | w/0 parts NH4Cl | | | | | |
| 2 | 75% Dispersion No. 2 | 19.4 | 108.6 | 3696 | 1584 | N/A |
| | 25% Dispersion No. 1 | | | | | |
| | w/0 parts NH4Cl | | | | | |
| 3 | 50% Dispersion No. 2 | 20.1 | 104.2 | 3701 | 1559 | 19.3 |
| | 50% Dispersion No. 1 | | | | | |
| | w/0 parts NH4Cl | | | | | |
| 4 | 25% Dispersion No. 2 | 19.9 | 106.3 | 3714 | 1436 | N/A |
| | 75% Dispersion No. 1 | | | | | |
| | w/0 parts NH4Cl | | | | | |
| 5 | 10% Dispersion No. 2 | 19.9 | 100.9 | 3589 | 1185 | 8.1 |
| | 90% Dispersion No. 1 | | | | | |
| | w/0 parts NH4Cl | | | | | |
| 6 | 100% Dispersion No. 1 | 19.6 | 102.9 | 3068 | 499 | 5.4 |
| | w/0 parts NH4Cl | | | | | |
| 7 | 100% Dispersion No. 2 | 20.5 | 103.9 | 3340 | 1877 | 52.5 |
| | w/1 parts NH4Cl | | | | | |
| 8 | 75% Dispersion No. 2 | 20.5 | 104.4 | 3779 | 1651 | N/A |
| | 25% Dispersion No. 1 | | | | | |
| | w/1 parts NH4Cl | | | | | |
| 9 | 50% Dispersion No. 2 | 21.0 | 99.8 | 3804 | 1590 | 19.3 |
| | 50% Dispersion No. 1 | | | | | |
| | w/1 parts NH4Cl | | | | | |
| 10 | 25% Dispersion No. 2 | 20.6 | 97.4 | 3637 | 1554 | N/A |
| | 75% Dispersion No. 1 | | | | | |
| | w/1 parts NH4Cl | | | | | |
| 11 | 10% Dispersion No. 2 | 20.3 | 106.9 | 3605 | 1213 | 8.1 |
| | 90% Dispersion No. 1 | | | | | |
| | w/1 parts NH4Cl | | | | | |
| 12 | 100% Dispersion No. 1 | 19.6 | 103.0 | 3081 | 980 | 5.4 |
| | w/1 parts NH4Cl | | | | | |
| 13 | 0% NH4Cl | 0.0 | 89.3 | 873 | 346 | N/A |
| | (Base Airlaid | | | | | |
| | Substrate) | | | | | |

The results in Table 1 demonstrate that as the level of Dispersion 2 (which is of the dispersion b) type) decreases in the formulation, there is a decrease in the wet tensile strength of the subsequent nonwoven. In addition, the level of formaldehyde in the dispersion blend at 50% solids also decreases. However, the decrease in wet tensile is not proportional to what each of the individual VAE should provide to the wet tensile performance and actually favours a higher level of wet tensile strength that what would not have been expected as the amount of Dispersion 2 decreases.

### Table 2 Calculation of Synergistic Contribution

The synergistic effect of the blends can be seen in Table 2 where the actual nonwoven wet tensile contribution of the VAE blends is compared with the theoretical measurements based on the individual contributions of each binder within the blend.

In Table 2, the contribution of each binder, alone and as a blend, is determined by subtracting the wet tensile measurement of the nonwoven alone (0% VAE binder) from the wet tensile of the actual measured value. For example, the 100% Dispersion 2 bound nonwoven had a wet tensile of 1620 grams/5 cm (example 14) and the wet tensile strength of the nonwoven without binder (example 26) had strength of 346 grams/5 cm. By subtracting example 26 from example 14, a value of 1274 grams/5 cm results which is the contribution of the binder to the strength of the fabric.

The theoretical wet tensile strength contribution of the binder blend is determined by multiplying the % of each VAE in the blend by the wet tensile strength wet strength contribution of the individual binder. For example, the blend in Example 17 is made up of 75% Dispersion 2 and 25% Dispersion 1. The contribution of the blend is calculated as follows: (75%×1274)+(25%×153)=993 grams/5 cm.

The difference between the actual wet tensile contribution of the VAE blend and the theoretical wet tensile contribution of the VAE blend, thus the synergistic contribution, is determined by subtracting the actual contribution of the VAE binder blend from the theoretical contribution. For example the synergistic contribution to the wet tensile in Example 17 (75% Dispersion 2 and 25% Dispersion 1) is calculated as follows: 1238 grams/5 cm−993 grams/5 cm=245 grams/5 cm where the value of 245 grams/5 cm is considered the synergistic contribution.

The last column in Table 2 is the percent improvement in wet tensile strength due to the synergistic contribution. The results show that without acid addition to the formulation, the synergistic contribution of the VAE blend to the nonwoven wet tensile strength ranged from 19.8% to 68.4% and with the acid the percent improvement ranged from 0% to 28.9%.

TABLE 2
% Increase in Nonwoven Wet Tensile due to VAE Blend Synergism

| | | Wet | Wet | Actual | Theoretical | Difference between | |
|---|---|---|---|---|---|---|---|
| | | Tensile | Tensile | Contribution | Contribution | Actual Wet Tensile | % Improvement |
| | | Strength | Strength of | to Wet | to Wet Tensile | and Theoretical Wet | to Wet Tensile |
| | | Substrate + | Substrate | Tensile | from | Tensile as | Strength |
| | | Binder | only | from Binder* | Binder Blend** | Contributed by | due to |
| Example | | grams/ | grams/ | grams/ | grams/ | Binder grams/ | Synergistic |
| No. | Condition | 5 cms | 5 cms | 5 cms | 5 cms | 5 cms | Effect |
| 14 | 100% Dispersion No. 2 | 1620 | 346 | 1274 | 1274 | 0 | N/A |
| | w 0 parts NH4Cl | | | | | | |
| 15 | 75% Dispersion No. 2 | 1584 | 346 | 1238 | 993 | 245 | 19.8 |
| | 25% Dispersion No. 1 | | | | | | |
| | w 0 parts NH4Cl | | | | | | |
| 16 | 50% Dispersion No. 2 | 1559 | 346 | 1213 | 713 | 499 | 41.1 |
| | 50% Dispersion No. 1 | | | | | | |
| | w 0 parts NH4Cl | | | | | | |
| 17 | 25% Dispersion No. 2 | 1436 | 346 | 1090 | 433 | 657 | 60.2 |
| | 75% Dispersion No. 1 | | | | | | |
| | w 0 parts NH4Cl | | | | | | |
| 18 | 10% Dispersion No. 2 | 1185 | 346 | 839 | 265 | 574 | 68.4 |
| | 90% Dispersion No. 1 | | | | | | |
| | w 0 parts NH4Cl | | | | | | |
| 19 | 100% Dispersion No. 1 | 499 | 346 | 153 | 153 | 0 | N/A |
| | w 0 parts NH4Cl | | | | | | |
| 20 | 100% Dispersion No. 2 | 1877 | 346 | 1531 | 1531 | 0 | N/A |
| | w 1 part NH4Cl | | | | | | |
| 21 | 75% Dispersion No. 2 | 1651 | 346 | 1305 | 1307 | −2 | 0 |
| | 25% Dispersion No. 1 | | | | | | |
| | w 1 parts NH4Cl | | | | | | |
| 22 | 50% Dispersion No. 2 | 1590 | 346 | 1244 | 1082 | 162 | 14.9 |
| | 50% Dispersion No. 1 | | | | | | |
| | w 1 parts NH4Cl | | | | | | |
| 23 | 25% Dispersion No. 2 | 1554 | 346 | 1208 | 858 | 350 | 28.9 |
| | 75% Dispersion No. 1 | | | | | | |
| | w 1 parts NH4Cl | | | | | | |
| 24 | 10% Dispersion No. 2 | 1213 | 346 | 867 | 723 | 144 | 19.9 |
| | 90% Dispersion No. 1 | | | | | | |
| | w 1 parts NH4Cl | | | | | | |
| 25 | 100% Dispersion No. 1 | 980 | 346 | 634 | 634 | 0 | N/A |
| | w 1 parts NH4Cl | | | | | | |
| 26 | 0% NH4Cl | 346 | 346.0 | 0 | 0 | N/A | N/A |
| | (Base Airlaid | | | | | | |
| | Substrate) | | | | | | |

*Measured VAE bound substrate wet tensile strength − measured substrate wet tensile w/o VAE binder
**Wet Tensile strength contributed by % of each binder combined based on Wet tensile of each at 100% For example; at 75% Dispersion 2/25% Dispersion 1 w/o ammonium chloride; the % wet tensile strength contributions = (75% × 1274) + (25% × 153) = 993 grams/5 cm

Other examples of the wet strength blend synergy between a NMA containing VAE and a PVOH stabilized VAE can be seen in Tables 3 and 4. Table 3 below illustrates the nonwoven wet tensile strength of airlaid substrates bound with various blends of Dispersion 3 and Dispersion 1. Dispersion 3 is similar to Dispersion 2 except that the Tg of Dispersion 3 is lower due to a greater amount of ethylene in the polymer. The airlaid substrate and method of application and testing is the same as that described above. Table 4 below illustrates the synergy between the Dispersion 3 and Dispersion 1. The calculations in Table 4 were made in a similar manner as Table 2.

TABLE 3
Wet/Dry Tensile Strength of Airlaid Bound with VAE Blend
Formulations Dispersion No. 3/Dispersion No. 1

| | | | | | | 50% Solids |
|---|---|---|---|---|---|---|
| | | | Substrate | Dry Tensile | Wet Tensile | Dispersion |
| Example | | Add-on | Basis weight | Strength | Strength | Formaldehyde |
| No. | Condition | % | grams/sq. meter | grams/5 cms | grams/5 cms | Level |
| 27 | 100% Dispersion No. 3 | 19.4 | 102.3 | 3082 | 1767 | 45.3 |
| | w/0 parts NH4Cl | | | | | |
| 28 | 25% Dispersion No. 3 | 19.5 | 104.6 | 3554 | 1248 | N/A |
| | 75% Dispersion No. 1 | | | | | |
| | w/0 parts NH4Cl | | | | | |
| 29 | 10% Dispersion No. 3 | 19.0 | 103.4 | 3445 | 985 | 9.2 |
| | 90% Dispersion No. 1 | | | | | |
| | w/0 parts NH4Cl | | | | | |
| 30 | 100% Dispersion No. 1 | 19.1 | 108.1 | 2997 | 649 | 5.6 |
| | w/0 parts NH4Cl | | | | | |
| 31 | 100% Dispersion No. 3 | 20.6 | 105.0 | 3077 | 2026 | 45.3 |
| | w/1 part NH4Cl | | | | | |
| 32 | 25% Dispersion No. 3 | 20.2 | 102.0 | 3469 | 1630 | N/A |
| | 75% Dispersion No. 1 | | | | | |
| | w/1 part NH4Cl | | | | | |
| 33 | 10% Dispersion No. 3 | 20.2 | 103.7 | 3245 | 1434 | 9.2 |
| | 90% Dispersion No. 1 | | | | | |
| | w/1 part NH4Cl | | | | | |
| 34 | 100% Dispersion No. 1 | 19.8 | 102.7 | 3138 | 1012 | 5.6 |
| | w/1 part NH4Cl | | | | | |

TABLE 4
% Increase in Nonwoven Wet Tensile due to VAE Blend Synergism Dispersion No. 3/Dispersion No. 1

| | | | Wet | Actual | Theoretical | Difference between | |
|---|---|---|---|---|---|---|---|
| | | Wet Tensile | Tensile | Contribution | Contribution | Actual Wet Tensile | % Improvement |
| | | Strength | Strength of | to Wet | to Wet Tensile | and Theoretical Wet | to Wet Tensile |
| | | Substrate + | Substrate | Tensile | from | Tensile as | Strength |
| | | Binder | only | from Binder* | Binder Blend** | Contributed by | due to |
| Example | | grams/ | grams/ | grams/ | grams/ | Binder grams/ | Synergistic |
| No. | Condition | 5 cms | 5 cms | 5 cms | 5 cms | 5 cms | Effect |
| 35 | 100% Dispersion No. 3 | 1767 | 346 | 1421 | 1421 | 0 | N/A |
| | w/0 parts NH4Cl | | | | | | |
| 36 | 25% Dispersion No. 3 | 1248 | 346 | 902 | 582 | 320 | 35.5 |
| | 75% Dispersion No. 1 | | | | | | |
| | w/0 parts NH4Cl | | | | | | |
| 37 | 10% Dispersion No. 3 | 985 | 346 | 639 | 741 | 0 | 0 |
| | 90% Dispersion No. 1 | | | | | | |
| | w/0 parts NH4Cl | | | | | | |
| 38 | 100% Dispersion No. 1 | 649 | 346 | 303 | 303 | 0 | N/A |
| | w/0 parts NH4Cl | | | | | | |
| 39 | 100% Dispersion No. 3 | 2026 | 346 | 1680 | 1680 | 0 | N/A |
| | w/1 part NH4Cl | | | | | | |
| 40 | 25% Dispersion No. 3 | 1630 | 346 | 1284 | 920 | 364 | 28.4 |
| | 75% Dispersion No. 1 | | | | | | |
| | w/1 parts NH4Cl | | | | | | |
| 41 | 10% Dispersion No. 3 | 1434 | 346 | 1088 | 767 | 321 | 29.5 |
| | 90% Dispersion No. 1 | | | | | | |
| | w/1 parts NH4Cl | | | | | | |
| 42 | 100% Dispersion No. 1 | 1012 | 346 | 666 | 666 | 0 | N/A |
| | w/1 parts NH4Cl | | | | | | |
| 43 | 0% NH4Cl | 346 | 346.0 | 0 | 0 | N/A | N/A |
| | (Base Airlaid | | | | | | |
| | Substrate) | | | | | | |

*Measured VAE bound substrate wet tensile strength − measured substrate wet tensile w/o VAE binder
**Wet Tensile strength contributed by % of each binder combined based on Wet tensile of each at 100% For example; at 25% Dispersion No. 3/75% Dispersion No. 1 w/o ammonium chloride; the % wet tensile strength contributions = (25% × 1421) + (75% × 303) = grams/5 cm

Table 5 assembles experimental data from the foregoing tables, comparing actual data obtained with the values expected by calculating a weighted average of the Dispersion 1 and Dispersion 2 values obtained from the 100/0 and 0/100 runs.

TABLE 5

| | Dry Tensile Strength | | Wet Tensile Strength | | Dry Tensile Strength | | Wet Tensile Strength | |
|---|---|---|---|---|---|---|---|---|
| Disp. 2/ | No NH₄Cl | | No NH₄Cl | | 1 part NH₄Cl | | 1 part NH₄Cl | |
| Disp. 1 | Theoretical | Actual | Theoretical | Actual | Theoretical | Actual | Theoretical | Actual |
| 100/0 | — | 3695 | — | 1620 | — | 3340 | — | 1877 |
| 75/25 | 3538 | 3696 | 1339 | 1584 | 3275 | 3779 | 1652 | 1651 |
| 50/50 | 3381 | 3701 | 1059 | 1559 | 3210 | 3804 | 1428 | 1590 |
| 25/75 | 3224 | 3714 | 779 | 1436 | 3145 | 3637 | 1204 | 1554 |
| 10/90 | 3130 | 3589 | 611 | 1185 | 3106 | 3605 | 1069 | 1213 |
| 0/100 | — | 3068 | — | 499 | — | 3081 | — | 980 |

As can be seen, the actual wet and dry tensile strengths obtained were in most cases significantly greater than the expected values, indicating a synergistic effect between Dispersion 1 and Dispersion 2.

Although the invention is illustrated and described herein with reference to specific embodiments, the invention is not intended to be limited to the details shown. Rather, various modifications may be made in the details within the scope and range of equivalents of the claims without departing from the invention.

What is claimed:

1. An aqueous composition comprising a blend of:
a) an aqueous dispersion of a vinyl acetate ethylene or vinyl acetate polymer, stabilized by polyvinyl alcohol and optionally also by a surfactant, wherein the polymer does not include units of any N-methylol-containing monomer; and
b) an aqueous dispersion of an N-methylol-containing vinyl acetate ethylene or vinyl acetate polymer, stabilized with a surfactant, polyvinyl alcohol or a combination thereof.

2. The composition of claim 1, further comprising a mineral acid or an ammonium salt thereof.

3. The composition of claim 2, wherein the ammonium salt is present and is ammonium chloride.

4. The composition of claim 1, wherein the polymer in part a) is a vinyl acetate ethylene copolymer.

5. The composition of claim 1, wherein the polymer in part b) is an N-methylol-containing vinyl acetate ethylene copolymer.

6. A method of increasing the wet strength of a fibrous nonwoven substrate, comprising applying to the substrate the aqueous composition of claim 1, followed by a drying step.

7. The method of claim 6, wherein the composition further comprises an acid.

8. The method of claim 7, wherein the acid is a mineral acid or an ammonium salt thereof.

9. The method of claim 8, wherein the acid is ammonium chloride.

10. The method of claim 6, wherein the drying step is performed at a temperature in a range from 120° C. to 160° C.

11. A fibrous nonwoven article made by the method of claim 6.
